(19) United States
(12) Patent Application Publication
(10) Pub. No.: US 2009/0167557 A1
(43) Pub. Date: Jul. 2, 2009

(54) ADVANCED METER SECURITY SYSTEM

(76) Inventors: John H. Bubb, Newport Beach, CA (US); David Jeffrey Gooding, Upland, CA (US); Jeremy McDonald, Carlsbad, CA (US)

Correspondence Address: SHELDON MAK ROSE & ANDERSON PC, 100 Corson Street, Third Floor, PASADENA, CA, 91103-3842, US

(21) Appl. No.: 11/964,569

(22) Filed: Dec. 26, 2007

(51) Int. Cl. G08C 19/16

(52) U.S. Cl. 340/870.01

(57) ABSTRACT

A system for metering electricity consumption securely between a central station comprising data storage and a security module, an electrical device having storage memory and an electrical meter that is in data communication with the central station and the device. The meter is capable of detecting the net energy contribution of the device and transmitting the data to the central station. The security module is capable of generating and transmitting a communication code to the device via the meter for storage in the device.

### FIELD

The invention pertains to the field of electric meters, and more specifically to an advanced electrical meter infrastructure for secure communications.

### BACKGROUND

Traditionally electric utilities respond to demand by monitoring overall operational data and conditions in real time. They also use estimates and historic averages to determine electricity demand. However, real time operating information from individual electrical devices has been difficult to obtain for decision making needs. Existing systems for communicating with electrical devices through a power meter have generally only turned the electrical devices on or off, depending upon the available power supply conditions. In effect, utility operators have limited knowledge as to what is happening in real time at the product delivery and ultimate consumption point, the electrical device.

A principal problem in gathering energy use data relative to an electrical device is that a utility's only interface with its consumers is via traditional electrical power meters. These meters only measure the aggregate power used by consumers over an extended period of time, typically a month, and the power usage must be manually obtained by vast teams of meter readers. Procedures for establishing communications between electrical devices and an electrical power utility are generally focused on providing a module into which an electrical device can plug, the module containing some rudimentary communications capabilities. Current plug-in modules communicate generically through an Internet Protocol (IP) address. Individual device identification is not used with such modules and the modules typically lack communications security. This can leave the device and the network vulnerable to hackers.

Accordingly, there is a need for a system and method of secure communication by a utility with electrical devices.

### SUMMARY

A system for metering electricity consumption securely comprises a central station with data storage and a security module, an electric meter with storage memory, and an electrical device having storage memory and capable of using or generating electricity connected to the electrical meter. The meter is in data communication with the central station and the electrical device. The meter can detect the net energy contribution of the electrical device and transmit that information to the central station for storage. The security module can generate a secure communications code that is transmitted to, and is stored by, the electrical device via the meter. The stored secure communications code provides secure communications between the utility and the electrical device. In another version of this system there are multiple meters and multiple electrical devices.

A method according to the present invention sets up an electrical device for secure data transmission to a central station through an electric meter. The central station receives data contained in the electrical device through the electrical meter. The central station generates a secure communications code based on the received data and transmits the secure communications code to the electrical device via the electric meter for storage. The method can be used to set up multiple electric devices using multiple meters.

A method for registering an electrical device for secure data transmission to a central station through an electric meter is provided. The electrical device contains a registration code that is associated with the electrical device. A user submits the registration code on a web site. The utility generates an authorization code that is sent to the electrical device. The electrical device generates a secure communications code, which can be generated by using a logic XOR operation on the registration code and the authorization code.

### DRAWINGS

These and other features, aspects and advantages of the present invention will become better understood with regard to the following description, appended claims, and accompanying drawings where:

FIG. 1 is a block diagram of an advanced meter infrastructure system for metering electricity consumption securely, the system having features of the present invention;

FIG. 2 is a block diagram of a another system for metering electricity consumption securely, the system comprising multiple electrical devices, the system having features of the present invention;

FIG. 3 is a flowchart of a method for registering an electrical device for secure data transmission to a central station through an electric meter for use in the systems of FIGS. 1 and 2;

FIG. 4 is a flowchart of a method for setting up an electrical device for secure data transmission to a central station through an electric meter for use in the systems of FIGS. 1 and 2; and

FIG. 5 is a flowchart of a method for setting up a plurality of electrical devices for secure data transmission to a central station for use in the systems of FIGS. 1 and 2.

### DESCRIPTION

The present invention overcomes limitations of the prior art by providing an advanced meter infrastructure (“AMI”) system for metering electricity consumption securely from an electrical device and providing security services that are callable by the electrical device. The present invention allows individual electrical devices to identify themselves and their capabilities to a utilities network and establish a secure communications channel automatically or manually.

As used in this disclosure, except where the context requires otherwise, the term “comprise” and variations of the term, such as “comprising”, “comprises” and “comprised” are not intended to exclude other additives, components, integers or steps.

The term “net energy contribution” means the amount of consumption of energy or generation of energy by a device or a system, such as, for example, solar power panels generate electricity and a refrigerator consumes electricity.

The term “registering” refers to establishing a secure communications link between two entities using cryptography, and preferably asymmetric cryptography.

Referring to FIG. 1, a system 100 for metering electricity consumption securely according to one embodiment of the present invention comprises an electrical device 102 having storage means 104 and an electric motor 106. The electrical device 102 is connected to the advanced electrical meter 106 with storage which has its own storage memory 108. The storage memory 104 and 108 can be a non-volatile random access memory (“RAM”), static RAM, erasable programmable memory or a dynamic RAM. The electrical device 102 can be any generator or consumer of electricity such as a heater, an air conditioner, a toaster, a pool pump and a solar device. The advanced electrical meter 106 is in data communication with a central station 110. The central station 110 has data storage 112 and a security module 114 that aggregates data transmitted by the advanced electrical meter 106. The security module 114 can optionally provide security policies to both the advanced electrical meter 106 and the electrical device 102, including descriptions of the communications environment and the operation of the electrical device 102. The electrical device 102 is capable of using electricity or capable of generating electricity or both, thereby having a net energy contribution. The electrical meter 106 is capable of detecting the net energy contribution of the electrical device 102 and transmitting the data to the central station 110 for storage in the central station 110 data storage 112.

The security module 114 is capable of generating a secure communications code for transmission to the electrical device 102 via the electrical meter for storage in the electrical device storage memory to secure the data communications between the electrical meter 106 and the central station 110. The storage memory 104 of the electrical device 102 and the meter storage memory 108 of the advanced electrical meter 106 can store the secure communications code generated by the security module 114.

Optionally, the security module 114 comprises: at least one field management service, such as, for example, periodic updating of meter reading devices; at least one automated security service, such as, for example, cryptographic key management; and/or at least one managed infrastructure service, such as, for example, device registration and auditing functionality such as, for example, current net energy use by the electrical device 102.

The storage memory 104 of the electrical device and/or the storage memory 108 of the advanced electrical meter 106 can contain pre-loaded data such as, for example, a cryptographic key or a random number. The secure communications code can comprise a public key and a private key pair and can be loaded in the storage memory 104 of the electrical device 102 at the time of manufacture.

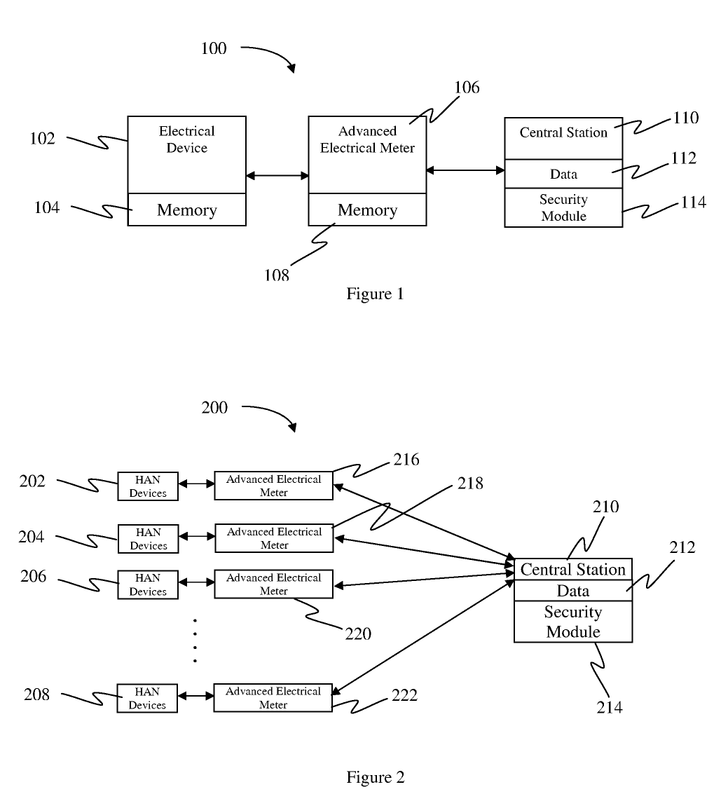

Referring now to FIG. 2, there is shown a block diagram of a system 200 for metering electricity consumption securely comprising multiple electrical devices. The system 200 comprises a central station 210 with data storage 212 and a security module 214 in data communication with multiple electric meters 216, 218, 220 and 222 and multiple electrical devices 202, 204, 206 and 208. The multiple electrical devices 202-208 each have storage memory (not shown) and are capable of using electricity or are capable of generating electricity or both, thereby having a net energy contribution. The multiple electrical meters 216-222 are capable of detecting the net energy contribution of the multiple electrical devices 202-208 and transmitting the data to the central station 210 for storage in the data storage 212. The security module 214 is capable of generating and transmitting a secure communications code to the multiple electrical devices 202-208 via their respective electrical meters 216-222 for storage in the storage memory of the multiple electrical devices 202-208.

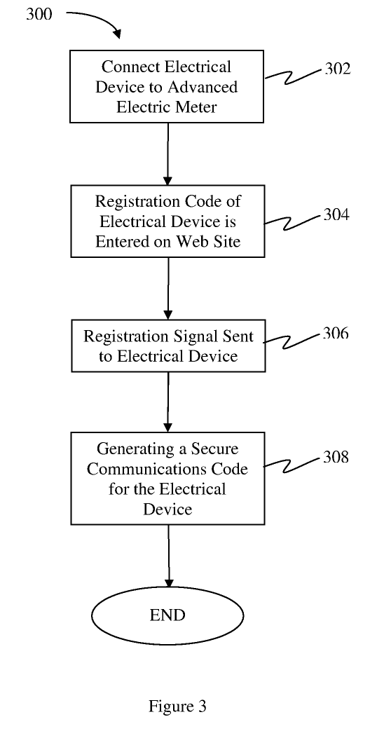

Referring now to FIG. 3, there is shown a flowchart 300 of a method for registering an electrical device for secure data transmission to a central station through an electric meter. A registration code associated with the electrical device, such as, for example, a 40 digit hexadecimal number is submitted to a web site 304. The web site is typically hosted by or for the electric utility. The registration code can be associated with the electrical device by various means such as, for example, a number printed on the electrical device or an alphanumeric code printed on a label attached to the electrical device. In response to the submission of the registration code, a registration signal is sent to the electrical device 306 via the meter. The registration signal includes an activation code. A secure communications code is generated for the electrical device. A preferred technique for generating the communications code is to use a logical XOR operation on the registration code and the received registration signal 308 and the registration of the electrical device is completed. The same code is generated by the utility from the submitted information and stored in the data storage of the central station. The electrical device and the utility can now communicate securely when the secure communications code of the electrical device matches that stored by the utility.

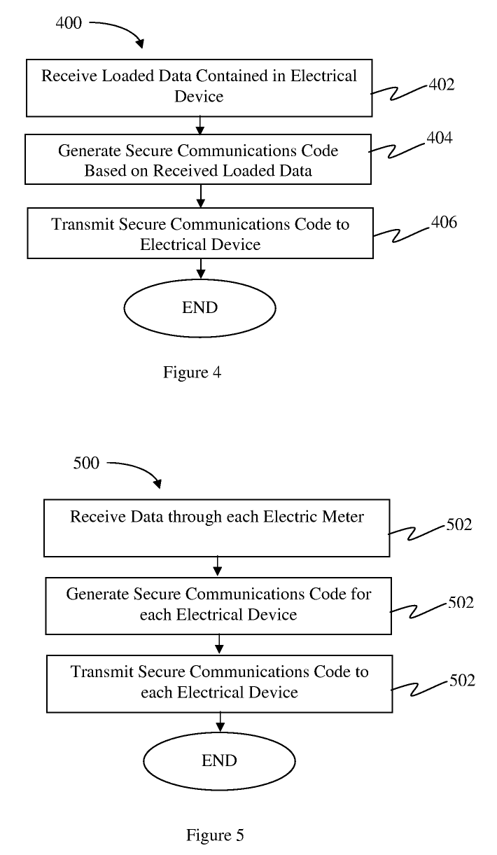

Referring now to FIG. 4, there is shown a flowchart of a method 400 for setting up an electrical device for secure data transmission to a central station through an electric meter. The method 400 comprises receiving 402 at the central station through each respective electric meter pre-loaded data contained in the storage memory of each electrical device. Optionally, the pre-loaded data is a random number input into the storage memory of the electrical device by a manufacturer, and the random number can comprise an error correcting code (“ECC”). Secure communications codes are generated 404 based on the pre-loaded data using a logical bitwise XOR operation with a private key held at the central station and the pre-loaded data. The secure communications codes are transmitted 406 to each electrical device via the electric meter for storage in each electrical device's storage memory.

Referring now to FIG. 5, there is shown a flowchart of a method 500 for setting up a plurality of electrical devices for secure data transmission to a central station. The method 500 comprises receiving 502 loaded data from an electrical device at a central station. The loaded data is transmitted from the plurality of electric meters to the central station. At the central station a secure communications code for each electrical device is generated 504 based on the loaded data transmitted from the electrical meters. The secure communications codes are transmitted 506 to the electrical devices via the corresponding electric meters for storage in the storage memories of the electrical devices.

Although the present invention has been discussed in considerable detail with reference to certain preferred embodiments, other embodiments are possible. For example, the storage memory 104 can be made up of multiple memory devices such as RAM and disks, EPROM, tape, CD's, DVD's and the 17½. Therefore, the scope of the appended claims should not be limited to the description of preferred embodiments contained in this disclosure. All references cited herein are incorporated by reference in their entirety.

What is claimed is:

1. A system for metering electricity consumption securely comprising:
a) a central station comprising data storage and a security module;
b) an electrical device having storage memory and capable of using electricity or capable of generating electricity or both, thereby having a net energy contribution; and
c) an electrical meter, the electrical meter being in data communication with the central station and the electrical device, and being capable of detecting the net energy contribution of the electrical device and transmitting the data to the central station for storage in the data storage, and
wherein the security module is capable of generating a secure communications code for transmission to the electrical device via the electrical meter for storage in the electrical device storage memory.

2. The system of claim 1, wherein the storage memory of the electrical device is capable of storing the communication code.

3. The system of claim 1, wherein the storage memory contains a pre-loaded cryptographic key.

4. The system of claim 1, wherein the electrical device is capable of generating electricity.

5. The system of claim 1, wherein the secure communications code comprises a public key and a private key pair.

6. The system of claim 1, wherein the secure communications code is loaded in the storage memory of the electrical device at the time of manufacture.

7. A system for secure data transmission comprising:
a) a central station comprising data storage and a security module;
b) multiple electrical devices having storage memory and capable of using electricity usage or capable of generating electricity or both, thereby having a net energy contribution; and
c) multiple electrical meters, each meter having associated therewith at least one electrical device, the multiple electrical meters being in data communication with the central station and at least one electrical device, and being capable of detecting the net energy contribution of the communicating electrical device and transmitting the data to the central station for storage in the data storage, and
wherein the security module is capable of generating a secure communications code for transmission to the electrical devices via the electrical meters for storage in the storage memory of the electrical devices.

8. A method for setting up an electrical device for secure data transmission to a central station through an electric meter, the electrical device having storage memory containing loaded data, the method comprising the steps of:
a) receiving at the central station, through the electrical meter, at least some of the loaded data contained in the first storage memory of the electrical device;
b) generating at the central station a secure communications code based on the received loaded data; and
c) transmitting the secure communications code to the electrical device via the electric meter for storage in the second storage memory of the electrical device.

9. The method of claim 8, wherein the loaded data is a randomly generated number.

10. The method of claim 9, wherein the randomly generated number comprises an error correcting code.

11. The method of claim 8, wherein the loaded data is embedded in the electrical device.

12. A method for registering an electrical device for secure data transmission to a central station through an electric meter, the electrical device having storage memory containing a registration code, the method comprising the steps of:
a) connecting the electrical device to the electric meter;
b) entering the registration code on a web site, where the registration code is associated with the electrical device;
c) receiving from the web site a registration signal based on the registration code; and
d) generating a secure communications code for the electrical device using a logic XOR operation on the registration code and the received registration signal.

13. A method for setting up a plurality of electrical devices for secure data transmission to a central station, each electrical device being in communication with a corresponding electric meter, there being a least two electric meters, each electric meter having associated therewith at least one electrical device, and each electrical device having storage memory containing loaded data, the method comprising the steps of:
a) receiving at the central station at least some of the loaded data through the electric meters;
b) generating at the central station a secure communications code for each electrical device based on the received loaded data; and
c) transmitting the secure communications code to each electrical device via its corresponding electric meter for storage in its storage memory.
